(19) United States
(12) Patent Application Publication
(10) Pub. No.: US 2007/0064099 A1
(43) Pub. Date: Mar. 22, 2007

(54) Method of representing a sequence of pictures using 3d models, and corresponding devices and signals

(76) Inventors: Raphaele Balter, Saint Sulpice la Foret (FR); Patrick Gioia, Servon Sur Vilaine (FR)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 10/561,070

(22) PCT Filed: Jun. 18, 2004
(86) PCT No.: PCT/FR04/01542

§ 371 Date: May 12, 2006

(51) Int. Cl. H04N 13/04

(52) U.S. Cl. 348/51

(57) ABSTRACT

The disclosure relates to a method of representing a sequence of pictures which are grouped into sets comprising at least two successive pictures, known as groups of pictures (GOP), whereby a textured, meshed three-dimensional model is associated with each of said GOPs. In an embodiment, the three-dimensional model associated with the n level GOP is represented with an irregular mesh taking account of at least one vertex of at least the irregular mesh representing the three-dimensional model that is associated with the n−1 level GOP, said vertex being known as the common vertex.

The field of the invention is that of the encoding of sequences of pictures (or images). More specifically, the invention relates to a technique for the encoding of sequences of pictures, by streams of the three-dimensional models, or 3-D models.

It may be recalled that video encoding by 3D models consists in representing a video sequence by one or more textured 3D models. The information to be transmitted to an encoder of the sequence of pictures consists of the 3D models, the pictures of textures associated with them and parameters of the camera that has filmed the sequence.

This type of encoding therefore makes it possible to attain lower bit rates than conventional encoding techniques in which the video sequences are generally represented by a set of pixels, which is far costlier to transmit.

Furthermore, as compared with conventional encoding techniques, such a technique of encoding by 3D models enables the adding of certain functions to the reconstructed sequence. It is thus possible to change the illumination of the scene, obtain stereoscopic display, stabilize the sequence (when it is a video sequence), add objects to the scene or change the viewpoint so as to simulate free navigation in the scene (free navigation may be defined as a change of path of the camera relative to the original path).

There is therefore a major demand in the picture encoding market for methods to extract 3D models from video sequences. Indeed, starting with real 3D scenes, 3D modeling is used to obtain content that is far more photo-realistic than that obtained in the methods of synthesis envisaged in the past. Furthermore, using the above-mentioned functions, the obtaining of virtual models of real scenes makes it possible to envisage a large number of applications such as applications in e-commerce, video games, simulation, special effects or again geographical localization.

Several techniques are known at present for the construction of 3D models from a video picture.

Certain techniques, known as active techniques, require control of the lighting of a real scene and generally use laser technology or a large number of cameras in order to acquire several angles of view and a large amount of data on depth.

Other techniques, known as passive techniques, rely for their part on sophisticated computation algorithms and are based either on the relationships between pictures or on silhouettes. They differ from one another chiefly by the level of calibration necessary and the degree of interactivity permitted. They consist of the reconstruction of a piece of 3D information from a set of photographs or pictures and come up chiefly against the following two problems:
establishing or determining correspondence, which consists in finding, for a zone of a given picture, a corresponding zone in the other pictures (this zone may be reduced to a point of the picture);
calibrating the camera which consists of the estimation of the picture-shaping parameters (namely, the intrinsic parameters of the camera (such as focal distance etc.) and its extrinsic parameters (the position of the camera for the acquisition of the different pictures of the sequence etc.)).

Establishing correspondence is generally done manually, as described by V. M. Bove and al. in “Semi-automatic 3D-model extraction from uncalibrated 2-D camera views,” Proceedings Visual Data Exploration and Analysis, 1995.

Calibration for its part is a painstaking process, and the computation algorithms associated with it are often unstable. Many methods therefore rely on calibrated sequences which require either human action (E. Boyer and al., “Calibrage et Reconstruction à l'aide de Parallélépipèdes et de Parallélogrammes,” (Calibration and Reconstruction through Parallelepipeds and Parallelograms) Proceedings of the 13^{th} French Speakers' Congress on Shape Recognition and Artificial Intelligence, 2002), or a complicated acquisition system, relying on a “turntable” (W. Niem, “Robust and Fast Modeling of 3D Natural Objects from Multiple Views”, vcip1994, 1994) or on the use of a mobile robot (J. Wingbermuhle, “Automatic Reconstruction of 3D Object Using a Mobile Monoscopic Camera,” Proceedings of the International Conference on Recent Advances in 3D Imaging and Modeling, Ottawa, Canada, 1997).

In certain other automatic or semi-automatic methods, establishing correspondence is not managed manually. Reference may be made for example to the techniques described by A. Fitzgibbon and al., (“Automatic Line Matching and 3D Reconstruction of Buildings from Multiple Views,” IAPRS, Munich, Germany, 1999) or C. Zeller and al., (“3-D Reconstruction of Urban Scene from Sequence of Images,” INRIA, Information Technology 2572, 1995).

However, these semi-automatic or automatic methods call for many assumptions to be made on the scenes to be reconstructed and can be applied for example to architectural scenes alone.

The methods of automatic 3D reconstruction conventionally implement the following steps:
detection of particular points or lines;
establishing correspondence between the pictures: in this step, the particular points or lines extracted during the previous steps are followed along the video sequence;
relating the different pictures to one another;
projective reconstruction of the 3D points;
autocalibration or refinement of the calibration, if necessary, to go for a metric 3D model (indeed, the interactive manipulations of the model are made in the Euclidean space);
estimation of the textured 3D model.

Certain approaches, based on the above algorithm, enable the reconstruction of a 3D model from data given by a monocular camera in motion (i.e. there is no a priori knowledge either of the intrinsic or extrinsic parameters of the camera or of the scene to be reconstructed). Reference may be made for example to the techniques described by P. Debevec and al. in “Panel Session on Visual Scene Representation,” Smile2000, 2000, or G. Cross and al., “VHS to VRML: 3D Graphical Models from Video Sequences,” IEEE International Conference on Multimedia Computing and System, Florence, 1999.

J. Röning and al. in “Modeling Structured Environments by a Single Moving Camera,” Second International Conference on 3-D Imaging and Modeling, 1999 have proposed a method that estimates a first model from detected contours and extended Kalman filters. However, this method has the drawback of relying greatly on contours and of being ill-suited to complicated scenes.

In “VHS to VRM: 3D Graphical Models from Video Sequences,” IEEE International Conference on Multimedia Computing and System, Florence, 1999, G. Cross and al. present a method for detecting points by the Harris method, and establishing their correspondence between the different views, simultaneously with the geometry estimation. The points are put into correspondence through cross correlation, combined with epipolar geometry between two views, or trifocal geometry between three views, which enables the guided matching. The cases of correspondence are then extended to the sequence and optimized by a bundle adjustment. We then obtain 3*4 projection matrices and a 3D Euclidean structure (by autocalibration), on which the texture of the original pictures is laid. This masks the imperfections of the geometry.

However, one drawback of this method is that the motion between two successive pictures has to be relatively small and that the sequence of pictures must be of a reasonable size. This method is therefore not suited to any sequence of pictures whatsoever.

Two approaches have also been proposed at the University of Louvain.

According to the first approach (M. Pollefeys, “Tutorial on 3D Modeling from Images,” eccv2000, 2000), the particular points or lines of the pictures detected are extracted and put into correspondence by means of Torr's algorithm (described in the above-mentioned work). At the same time, a restricted calibration is evaluated in order to enable the elimination of the correspondences incompatible with the calibration. Beardsley's method (M. Pollefeys, “Tutorial on 3D Modeling from Images,” eccv2000, 26 Jun. 2000, Dublin, Ireland) is used to obtain a coarse projective reconstruction for the first two pictures and the projection matrices of the other views. An autocalibration, in fixing certain unknown quantities at their default values and in applying the concept of the absolute conic makes it possible to retrieve the internal parameters of the camera in order to pass to a metric representation. The pieces of information are then merged into a common 3D model, by means of a method that concatenates the points which correspond to each other on several pictures (a downward chain and arising chain), from maps of disparities and rotations computed during the calibration. For big objects, a multi-resolution approach is proposed.

However, one drawback of this technique is that the multi-resolution approach proposed for the big objects requires the availability of several video sequences of the same scene in order to have access not only to an overall view but also to the details. Furthermore, this method is of a semi-automatic type.

According to a second technique (Gool and al., “From image sequences to 3D models,” Third International Workshop on Automatic Extraction of Man-made Objects from Aerial and Space Images, 2001), the particular points or lines of the pictures are detected by the Harris or by the Shi and Tomasi method (described by M. Pollefeys, in “Tutorial on 3D Modeling from Images,” eccv2000, 26 Jun. 2000, Dublin, Ireland). These characteristics are then put into correspondence, or followed between the different views, depending on whether they relate to pictures or video sequences. From these correspondences, the relations between the views are computed by a robust method such as the Torr or Fisher and Bolles method. For the projective reconstruction, two images or pictures are selected in order to obtain an initial reconstruction, in determining the projection matrices for the intrinsic parameters and an approximate rotation matrix, and by triangulation. The position of the cameras corresponding to the other views is then determined by means of epipolar geometry. The structure is then refined by the use of a Kalman filter (described by M. Pollefeys, in “Tutorial on 3D Modeling from Images,” eccv2000, 26 Jun. 2000, Dublin, Ireland) extended for each point. When the structure and motion have been obtained for the entire sequence, a bundle adjustment is made. A passage is made from the projective reconstruction to the Euclidean reconstruction through autocalibration. The virtual 3D model is then obtained by raising the triangular mesh on one of the pictures of the sequence, in eliminating the points for which the depth is not available.

One drawback of this method is that it does not give good results except for the simple scenes and is not suited to complex scenes.

More generally, all the prior art techniques described here above have the drawback of calling for simplifying assumptions to be made on the acquisition of the sequence of pictures (in terms for example of parameters of the camera) and/or on the content of the scene or again on the length of the sequence. In other words, these different methods are not suited to any unspecified and possibly complex scene and sequence of pictures.

A final method, which is an encoding oriented method, has been proposed by Franck Galpin in “Représentation 3D de séquence vidéo: schéma d'extraction automatique d'un flux de modèles 3D, applications à la compression et à la réalité virtuelle” (3D representation of video sequences: scheme for the automatic extraction of a stream of 3D models, application compression and to virtual reality), University of Rennes 1, 2002. Unlike in the other methods of the prior art, in which it is sought to reconstruct a single 3D model for the entire sequence of pictures, the main idea of the method of Franck Galpin is a piecewise processing of the video sequences in order to obtain several models, each of which will be valid for one section of the sequence, known as GOP (or group of pictures).

It is assumed that the scene is static (or segmented in the sense of the motion), filmed by a monocular camera in motion, that the acquisition parameters (the intrinsic and extrinsic parameters of the camera) are unknown, that the focal length of the camera is constant and that the scene contains no or few specular surfaces. The content of the scene and the motions of the camera are assumed to be any unspecified content and motions.

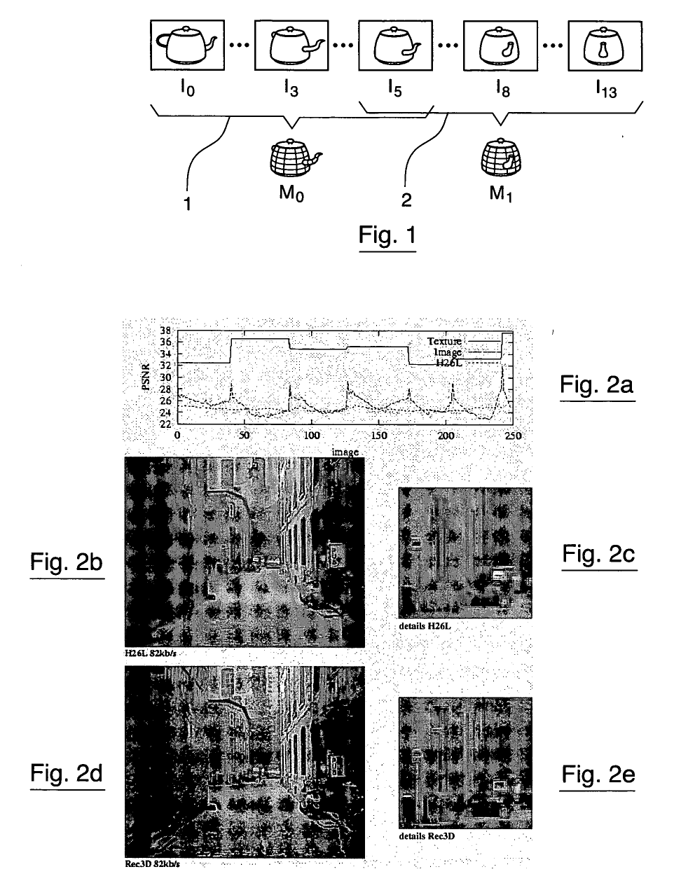

A dense estimation of the motion is made, based on the equation of the optical flow or on a deformable 2D mesh, in order to enable an estimation between the remote pictures of the sequence (namely the key pictures that demarcate the GOPs). The key pictures are selected in parallel and serve as a support for the estimation of the 3D model. The robust computation of the intrinsic and extrinsic parameters of the cameras is also made on the key pictures, and refined simultaneously with the 3D geometry by a method of sliding-window bundle adjustment. The positions of the intermediate pictures are estimated by localization by Dementhon (see especially Franck Galpin “Représentation 3D de séquence vidéo: schéma d'extraction automatique d'un flux de modèles 3D, applications à la compression et à la réalité virtuelle” (3D representation of video sequences: scheme for the automatic extraction of a stream of 3D models, application compression and to virtual reality), University of Rennes 1, January 2002) in order to enable the reconstruction of the original sequence, as illustrated in FIG. 1.

The initial sequence includes a plurality of successive pictures Iₖ, combined in groups of pictures called GOPs. Thus, the pictures I₀ to I₅ are grouped together within a first GOP referenced 1, having a 3D model M₀. associated with it. The pictures I₅ to I₁₃ are assembled within a second GOP referenced 2, having a second model M₁ associated with it.

This last-mentioned prior art method can be used to obtain far better results in terms of encoding than those given by the other methods described here above in this document. FIGS. 2a to 2e illustrate the results obtained, at low bit rate, according to this technique on the one hand and according to the H26L technique on the other. More specifically, FIG. 2a shows the development of the PSNR, FIGS. 2b and 2c respectively show a picture and a detailed zone of this picture obtained according to the H26L technique (or H264 technique, see especially “Sliding adjustment for 3D video representation”, Franck Galpin and Luce Morin, eurasip 2002, pages 1088 to 2001) for a bit rate of 82 kb/s, and FIGS. 2d and 2e show the same pictures obtained according to the method using streams of the 3D models according to Franck Galpin.

In FIG. 2a, the first curve (the highest in the figure) pertains to the objective quality of the reconstructed sequence, obtained by reprojection of the 3D models according to the method of Franck Galpin in the texture space, i.e. without taking account of the geometrical distortions. The other two curves of FIG. 2a indicate the objective quality for the reconstructed sequences obtained by the method of Franck Galpin and by the H264 encoder in the picture space.

Although in terms of objective measurement (i.e. in terms of PSNR or peak signal-to-noise ratio), the performance obtained is similar for the Franck Galpin encoder and the H26L encoder, it will be noted that, from a visual point of view, the quality obtained is greater with the encoder based on a 3D model stream, especially in terms of fidelity to details, absence of block effects etc.

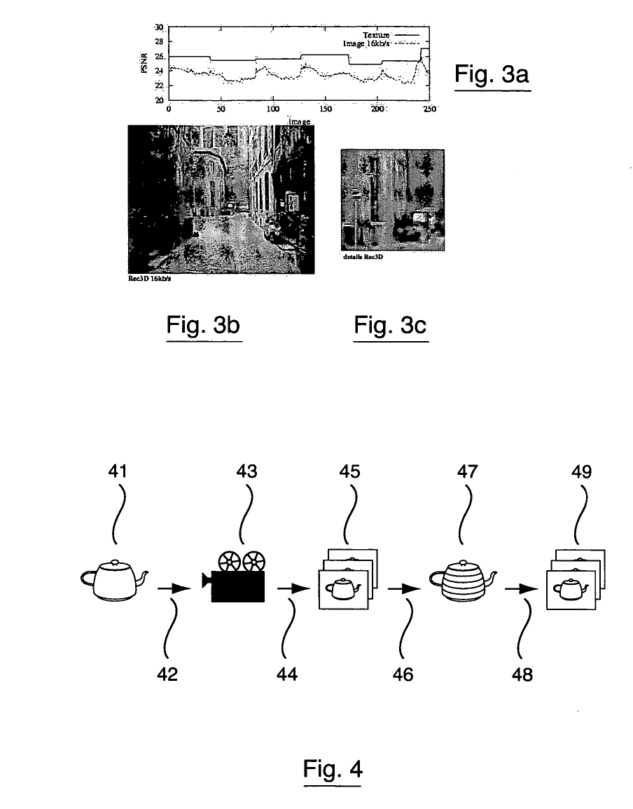

Furthermore, this encoding technique based on a stream of 3D models can be used to obtain very low bit rates with satisfactory visual quality, as illustrated by FIGS. 3a to 3c, which respectively show:

the evolution of the PSNR;

a picture obtained according to this technique;

a detailed region of this picture; for a bit rate of 16 kb/s.

Although Franck Galpin's method, relying on the extraction of a stream of 3D models, does not show certain drawbacks inherent in the methods of extracting a single 3D model described here above, it nevertheless comes up against certain problems.

In particular, one drawback of this prior art technique is that all the 3D models obtained for a sequence of pictures are only partially redundant, thus making this technique unsuited to applications of free navigation in a scene.

Indeed, the different 3D models obtained are expressed in different reference systems and show numerous imperfections (in terms of drift, aberrant points etc).

Another drawback of this prior art technique is that, although it is oriented toward encoding (unlike in the other approaches described here above), it is scalable only from the viewpoint of the texture of the pictures, and not from that of the geometry.

This method is therefore unsuited or ill-suited to implementation in display terminals having a very wide variety of processing capacities or to transmission networks of variable bit rate.

The invention is aimed especially at overcoming these drawbacks of the prior art.

More specifically, it is a goal of the invention to provide a technique for the representation of a sequence of pictures by 3D models that is suited to any type of sequence of fixed or static pictures, or scenes, including complex ones. In particular, it is the goal of the invention to implement a technique of this kind that enables the reconstruction of a scene, on which no assumption is made, that is acquired with an apparatus that is a large-scale consumer product, for which neither the characteristics nor the movement is known.

It is another goal of the invention to implement a technique of this kind that can be used to obtain a sequence reproduced by reprojection of high visual quality, even when there is a movement away from the original path of the camera used for the acquisition of the sequence.

It is yet another goal of the invention to provide a technique of this kind that is suited to low and very low bit rates.

It is also a goal of the invention to implement a technique of this kind that is particularly well suited to large-sized scenes.

It is yet another goal of the invention to provide a technique of this kind that is suited to applications of encoding and virtual navigation.

It is yet another goal of the invention to implement a technique of this kind that can be used to obtain scalable representations of the sequence of pictures, so as to enable transmission on networks with different bit rates, especially for portable applications.

Yet another goal of the invention is to provide a technique of this kind that can be used, for the same bit rate, to represent scenes of higher visual quality than with Franck Galpin's technique described here above.

It is also a goal of the invention to implement a technique of this kind that can be used, when representing a sequence of pictures of a same visual quality, to obtain a reduction of the bit rate as compared with the Franck Galpin's technique described here above.

These goals, as well as others that shall appear here below are achieved by means of a method for representing a sequence of pictures grouped in sets of at least two successive pictures, called GOPs, a textured, meshed 3D model being associated with each of said GOPs.

According to the invention, the 3D model associated with the GOP of level n is represented by means of an irregular mesh taking account of at least one vertex of at least the irregular mesh representing the 3D model associated with the GOP of level n−1, said vertex being called common vertex.

Thus, the invention relies on a wholly novel and inventive approach to the representation of a sequence of pictures by 3D models. Indeed, as in the case of the method proposed by Franck Galpin, the invention proposes an approach that relies not on the extraction of a unique 3D model for all the pictures of the sequence but on the extraction of a stream of 3D models, each associated with a group of pictures called a GOP.

Furthermore, the invention proposes an inventive improvement in the Franck Galpin technique by setting up a correspondence between the different 3D models associated with each of the GOPs, in particular so as to increase their redundancy. The invention therefore advantageously enables interactive navigation type applications.

A correspondence of this kind between successive 3D models is made possible through the use of an irregular mesh of the pictures that is particularly well suited to the singularities of the pictures. The irregular mesh of a 3D model thus takes account of at least one singular vertex (or more generally the particular points or lines of the picture) of the irregular mesh of the previous 3D vertex.

Thus, for equal visual quality, the invention reduces the bit rate of transmission of the sequence of pictures, owing to the redundancy between the different 3D models. It also makes it possible, for a same bit rate, to obtain better visual quality of the representation of the sequence of pictures, through the tracking of the singularities of the picture between successive 3D models.

According to an advantageous characteristic of the invention, at least two consecutive 3D models also have, associated with them, a basic model, built from said vertices common to said at least two 3D models.

Depending on the nature of the sequence of pictures, it is possible that all the 3D models associated with the sequence have a same basic mesh corresponding to them. This basic mesh, or coarse mesh for which the different 3D models constitute refinements, corresponds to the geometrical structure common to all the 3D models that are associated with it.

Preferably, the passage from one of said 3D models to another is done by wavelet transformation, using a first set of wavelet coefficients.

Advantageously, one of said three-dimensional models is obtained from said associated basic model by wavelet transformation, using a second set of wavelet coefficients.

The invention therefore enables a scalable transmission of the sequence of pictures that can be adapted as a function of the characteristics of the network or of the display terminal. The elements to be transmitted for a reconstruction of the sequence are, in addition to the parameters of the camera, firstly the basic mesh and, secondly, the different wavelet coefficients used to reconstruct the different 3D models. The transmission of a variably large number of wavelet coefficients gives a variably high reconstruction quality adapted to the bit rate at the transmission network or the capacity of the display terminal.

Preferably, said irregular mesh of level n is a two-dimensional irregular mesh of one of the pictures of said GOP of level n.

Advantageously, said meshed picture is the first picture of said GOP of level n.

Preferably, each of said three-dimensional models is obtained by elevation of said irregular mesh representing it.

Thus the depth information is combined with the 2D mesh to obtain a meshed depth map by elevation.

According to a first advantageous variant of the invention, said irregular two-dimensional mesh is obtained by successive simplifications of a regular triangular mesh of said picture.

For example, the operation starts from triangles with a side 1, to cover all the points of the picture.

According to a second advantageous variant of the invention, said irregular two-dimensional mesh is obtained from a Delaunay mesh of predetermined points of interest of said picture.

These points of interests are preliminarily detected, for example, by the Harris and Stephen algorithm.

Preferably, two successive GOPs have at least one common picture.

Thus, the last picture of a GOP is also the first picture of the next GOP.

According to an advantageous characteristic of the invention, said vertices common to said levels n−1 and n are detected by estimation of motion between the first picture of said GOP of level n−1 and the first picture of said GOP of level n.

Advantageously, a method of this kind includes a step for the storage of said detected common vertices.

These stored common vertices may then be used for the construction of a model associated with the next GOP.

Preferably, said irregular mesh representing said model associated with the GOP of level n also takes account of at least one vertex of at least the irregular mesh representing the model associated with the GOP of level n+1.

By acting bidirectionally in this way, the visual quality is furthermore increased during the reconstruction.

Advantageously, said second set of wavelet coefficients is generated by the application of at least one analysis filter on a semi-regular re-meshing of said associated three-dimensional model.

It may be recalled that a semi-regular mesh is a mesh for which those vertices that do not have six neighbors are isolated on the mesh (i.e. they are not mutually neighboring meshes).

Preferably, said wavelets are second-generation wavelets.

Preferably, said wavelets belong to the group comprising:
piecewise affine wavelets;
polynomial wavelets;
wavelets based on the Butterfly subdivision scheme.

The invention also relates to a signal representing a sequence of pictures grouped in sets of at least two successive pictures called GOPs, a textured, meshed 3D model being associated with each of said GOPs.

According to the invention, such a signal comprises:
at least one field containing a basic model built from vertices common to at least two irregular meshes, each representing a three-dimensional model, said at least two three-dimensional models being associated with at least two successive GOPs;
at least one field containing a set of wavelet coefficients used for the construction, by wavelet transformation from said basic model, of at least one three-dimensional model associated with one of said GOPs;
at least one field containing at least one texture associated with one of said three-dimensional models;
at least one field containing at least one camera position parameter.

The invention also relates to a device for representing a sequence of pictures implementing the representation method described here above.

The invention also relates to a device for representing a sequence of pictures grouped in sets of at least two successive pictures, called GOPs, a textured, meshed 3D model being associated with each of said GOPs.

According to the invention, such a device comprises:
means for the building of said three-dimensional models by wavelet transformation of at least one basic model, prepared from vertices common to at least two irregular meshes representing two successive three-dimensional models;
means for representing said picture of the sequence from said three-dimensional models, from at least one picture of texture, and from at least one camera position parameter.

The invention also relates to a device for the encoding of a sequence of pictures assembled in sets of at least two successive pictures, called GOPs, a textured, meshed 3D model being associated with each of said GOPs.

According to the invention, an encoding device of this kind comprises means for the encoding of a three-dimensional model associated with the GOP of level n, said three-dimensional model being represented by means of an irregular mesh taking account of at least one vertex of at least one irregular mesh representing the three-dimensional model associated with the GOP of level n−1.

Other features and advantages of the invention shall appear more clearly from the following description of a preferred embodiment, given by way of a simple, non-restrictive example and from the appended drawings, of which:

FIG. 1, already commented upon with reference to the prior art presents the principle of the reconstruction of a video sequence by means of a stream of 3D models;

FIGS. 2a to 2e, already commented upon with reference to the prior art, illustrate a comparison of the visual results obtained according to an H26L type technique in the one hand and the encoding technique of FIG. 1 on the other hand;

FIGS. 3a to 3c, already commented upon with reference to the prior art, present the results obtained according to the technique of FIG. 1 for a low bit rate of 16 kb/s

FIG. 4 illustrates the general principle of the reconstruction of a video sequence from a 3D model;

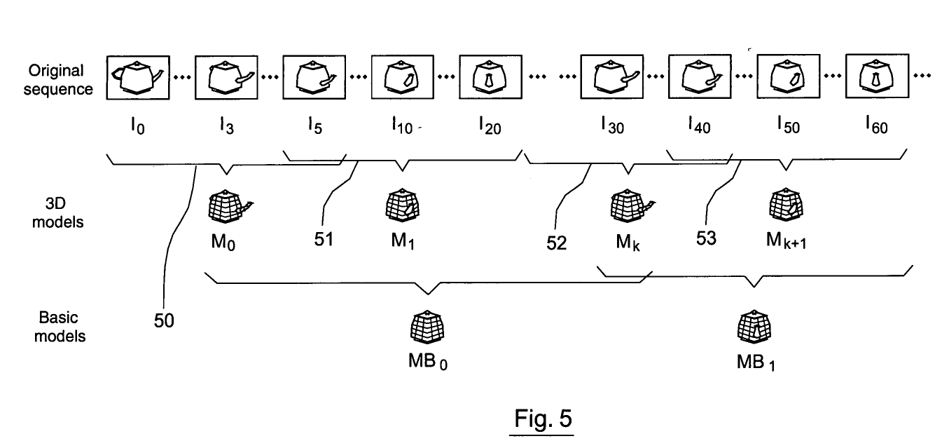

FIG. 5 illustrates the general principle of the present invention, relying on the extraction of a stream of 3D models, each associated with a basic model, common to one or more 3D models;

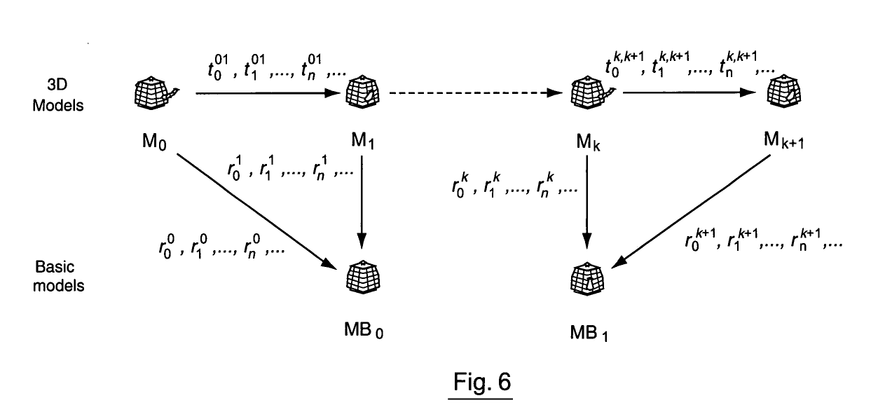

FIG. 6 presents the different wavelet coefficients used for the encoding of the 3D models of FIG. 4;

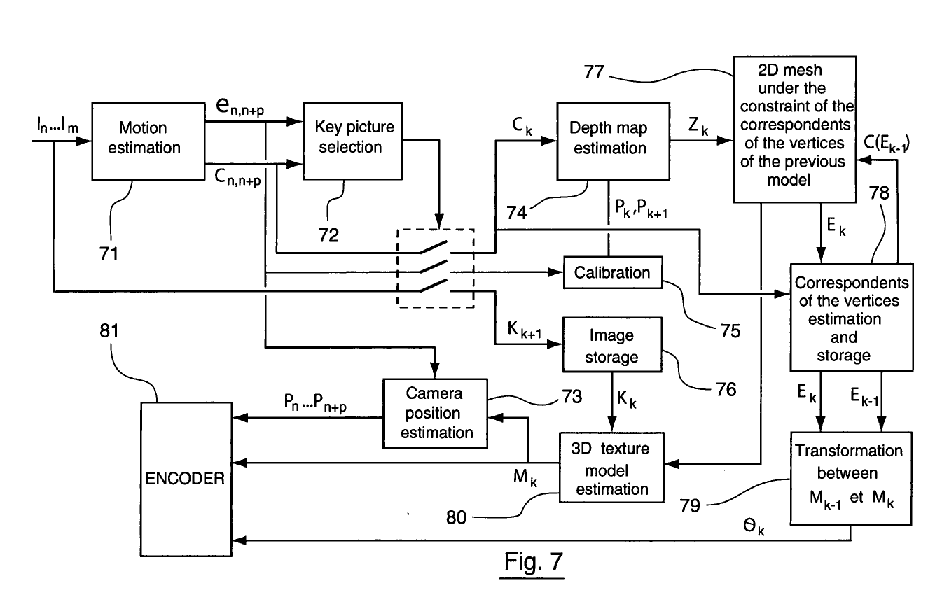

FIG. 7 is a block diagram of the different steps implemented according to the invention for the encoding of the pictures of the sequence.

The general principle of the invention is based on the extraction of a stream of 3D models with which irregular meshes are associated, suited to the content of the pictures of the sequence and taking account of the correspondents of the vertices of the irregular mesh of the preceding 3D model.

Referring to FIG. 4, we may briefly recall the general principle of the reconstruction of a video sequence by means of a three-dimensional model.

We consider a real scene, in this case an object 41 (a teapot herein) that is filmed (42) by means of a camera 43. No assumption is made either on the nature of this camera, which may be a large-scale consumer product, or on the parameters of acquisition of the video sequence.

After digitization 44 of the video sequence, a sequence of pictures 45, which shall be called an original sequence, is obtained.

By analysis 46 of this original sequence, at least one 3D model 47 is built (a plurality of 3D models according to the invention), from which it is possible to rebuild (48) a sequence of pictures 49, for display on a display terminal.

Referring now to FIG. 5, we present the general principle of the invention, which is based firstly on a stream of textured, meshed 3D models and, secondly, on the implementation of wavelet transformations.

Each 3D model corresponds to a part of the original sequence of pictures, i.e. to a GOP (or group of pictures). The 3D models considered are irregularly meshed elevation maps that are irregularly meshed under the constraint whereby the correspondents of the vertices of the previous model are taken into account. This constraint ensures precise correspondence between the vertices of the successive models.

The transformations used to pass from one model to another are decomposed into wavelets, thus enabling the precision of the transformation to be adapted to the bit rate, through the natural scalability of the wavelets.

The invention furthermore relies on the reconstruction of basic models, that are associated with one or more successive GOPs, as shown in FIG. 4.

The original sequence of pictures is constituted by successive pictures Iₖ. FIG. 4 more particularly shows the pictures I₀, I₃, I₅, I₁₀, I₂₀, I₃₀, I₄₀, I₅₀, and I₆₀. This sequence may be of any unspecified length, no restrictive hypothesis being necessary in the present invention.

The sequence of pictures Iₖ is divided into successive groups of pictures called GOPs. Thus, the first GOP 50 includes the pictures referenced I₀ to I₅, the second GOP 51 includes the pictures I₅ to I₂₀, a (k+1)^{th} GOP 52 includes especially the pictures I₃₀ to I₄₀ and a (k+2)^{th} GOP 53 includes the pictures I₄₀ to I₆₀. It will be noted that, in the preferred embodiment of FIG. 4, the last picture of a GOP is also the first picture of the next GOP: thus, the picture I₅ for example belongs to the first GOP 50 and to the second GOP 51.

For each of these GOPs 50 to 53, a 3D model Mₖ is built. The 3D model M₀ is associated with the GOP 50, the 3D model M₁ is associated with the GOP 51, etc.

A set of basic models, reference MBₖ, of which the 3D models Mₖ constitute refinements, is also built. Thus, in FIG. 4, the basic model MB₀ is associated with the 3D models M₀ à Mₖ, and the basic model MB₁ is associated with the 3D models Mₖ, Mₖ₊₁ and the 3D that follow them.

It is chosen to associate a coarse model MBₖ such as this with the 3D models of all the GOPs along which a set of predetermined particular points can be followed. When some of these points are no longer apparent in the next 3D model, it is chosen to pass to a new basic model MBₖ₊₁.

It is thus possible to decompose the different 3D models Mₖ, that have been obtained separately but are all based on a same basic mesh, namely that of the associated common coarse model, into wavelets.

Depending on the nature of the pictures of the original sequence, and the existence of common zones between these pictures in variably large numbers, the basic mesh MBₖ could be valid for a variable number of GOPs or even, as the case may be, for the entire sequence of pictures.

Through these basic models MBₖ, it is thus possible to express each estimated 3D model Mₖ firstly by the basic mesh that corresponds to it and secondly by a set of wavelet coefficients.

This representation is summarized in the drawings of FIG. 6, in which the coefficients tᵢ^{k} represent the wavelet coefficients pertaining to a transformation of passage from one 3D model Mₖ to the next one and in which the coefficients rᵢ^{k} represent the wavelet coefficients pertaining to a refinement between a basic model MBₖ and an associated 3D model Mₖ.

Thus, the wavelet coefficients t₀^{k,k+1} to tₙ^{k,k+1} are used to pass from a model Mₖ to the 3D model Mₖ₊₁. The wavelet coefficients r₀^{k} to rₙ^{k} for their part illustrate the passage from a 3D model Mₖ to the associated basic model (in this case, the model MB₁).

The first set of wavelet coefficients tᵢ^{k} therefore defines the links between the different models Mₖ, thus enabling passage from one to the other and a generation of intermediate models, either by linear interpolation between the correspondents or implicitly through the wavelets.

The second set of wavelets rᵢ^{k} provides for gradual and efficient (in terms of bit rate) transmission of the different models. Thus the technique of the invention can be adapted to all types of terminals, whatever their processing capacity, and to all types of transmission networks, whatever their bit rate.

Referring here below to FIG. 7, we present the different steps implemented according to the invention, during the encoding of the models and associated textures for representing an original sequence of pictures.

At the input of the algorithm, there is a set of natural pictures Iₙ to Iₘ, corresponding to different shots taken of a scene or of an object of the real world, as illustrated here above with reference to FIG. 4. In a preferred embodiment of the invention, the pictures are in the ppm format and in the pgm format. The invention can of course be applied also to any other picture format.

First of all, a motion estimation 71 is made between the different pictures of the original sequence, so as to determine the motion field C_{n,n+p} between the pictures Iₙ and Iₙ₊ₚ, as well as all the support points for the estimation of the 3D information, namely the set ε_{n,n+p} of the vertices of the mesh used for the motion estimation between the pictures Iₙ and Iₙ₊ₚ, having the highest scores with the Harris and Stephen detector and being regularly decimated.

A selection is then made (72) of the key pictures Kₖ of the original sequence, which demarcate the different GOPs of the sequence.

If the original sequence is a video sequence, then the selection 72 of the key pictures Kₖ demarcating the GOPs, is made according to the algorithm developed by Franck Galpin and al. in “Sliding Adjustment for 3D Video Representation” EURASIP Journal on Applied Signal Processing 2002:10 (see especially paragraph 5.1. Selection Criteria). This selection 72 of starting and ending GOPs therefore relies upon the validation of three criteria:
an average motion sufficient for the reconstruction of the 3D information;
a relatively high percentage of common points between the two farthest pictures of the GOP;
the validity of the estimated geometry (evaluated through the epipolar residual).

The first selected key picture for its part is the first picture I₀ of the original sequence.

The extraction of the 3D models Mₖ, i.e. the estimation of the fundamental matrix and the estimation of the projection matrices and of the camera positions 73, also make use of the techniques developed by Franck Galpin in “Représentation 3D de séquences vidéo: Schéma d'extraction automatique d'un flux de modèles 3D, applications à la compression and à la réalité virtuelle,” (3D representation of video sequences: scheme for the automatic extraction of a stream of 3D models, application compression and to virtual reality), University of Rennes 1, 2002 and in “Sliding Adjustment for 3D Video Representation” EURASIP Journal on Applied Signal Processing 2002:10. The techniques rely on the classic algorithms of 3D modeling.

In the case not of a video sequence but of a set of pictures, the principle is the same for the extraction of 3D information. However, the basis of this estimation is a set of particular points of the current picture having a high score for that the Harris and Stephen detector (described in “A Combined Corner and Edge Detector,” Proc. 4th Alvey Vision Conf., 1988), for which the correspondents in the next picture are sought by block matching. Furthermore, the number of models to be transmitted is limited by implementing a selection 72 of the pictures to be taken into account for the reconstruction of the original sequence. This selection 72 is based on the same criteria as a selection of the key pictures in the case of a video sequence.

After selection 72 of the key pictures Kₖ of the GOP k, the motion field Cₖ associated with the GOP k is therefore determined as being the motion field between the GOP k starting and ending pictures.

A calibration 75 is also carried out to determine all the intrinsic and extrinsic parameters of the camera used for the acquisition of the sequence of pictures, and especially the position Pₖ of the camera associated with the picture Iₖ.

With firstly this position Pₖ and, secondly, the field of motion Cₖ associated with the GOP k being known, an estimation (74) is made of the depth map Zₖ associated with the GOP k.

All the key pictures Kₖ of the original sequence associated with the GOPs k are also saved (76).

Reference may be made to the two publications by Franck Galpin referred to here above for the more particular mode of operation of the blocks referenced 71 to 76 in FIG. 7.

With a view to reconstruction, a two-dimensional irregular mesh 77 is made of the depth maps Zₖ, under the constraint wherein the correspondents of the vertices of the model associated with the previous GOP, contained in the picture Kₖ, are taken into account.

This 2D mesh may be computed in two ways:
through successive simplifications from a regular mesh of triangles with a side 1 (i.e. all the points of the picture);
through a Delaunay mesh of points of interest detected beforehand.

When the mesh has been determined at the level n, an estimation (78) is made, by means of the motion field Cₙ, of the correspondents of these points in the last picture of the GOP n (which is also, in a preferred embodiment of the invention, the first picture of the GOP n+1). This list of corresponding vertices is also stored (78) and used during the meshing 77 of the model associated with the GOP n+1.

In the case of the 2D mesh obtained by simplification, a constraint is applied whereby the points of this list 78 are present in the final mesh.

In the case of the Delaunay mesh, the vertices of the mesh associated with the GOP n+1 obtained by a Delaunay triangulation are:
the particular points detected by the Harris and Stephen algorithm (“A Combined Corner and Edge Detector,” Proc. 4th Alvey Vision Conf., 1988), or any other adequate detector of points of interest, on the key picture Kₙ₊₁ of the GOP n+1;
the correspondents of the vertices of the mesh associated with the GOP n.

The list of the correspondents C(Eₙ) computed at the level n can be used to take account of the vertices of the model of the GOP n that would not be among the vertices detected by Harris in the key picture of the GOP n+1.

This provides an assurance of the presence of the correspondents of the vertices of one model in the next model, thus amply facilitating the link 79 between these two models. Indeed, the correspondences 79 between the models could be obtained with precision through the field of motion.

In one alternative embodiment of the invention, to obtain a yet more precise transformation 79, this study is made bidirectional by placing the mesh of the current model under a constraint whereby it is not only the vertices of the previous model but also the vertices of the next model that are taken into account.

The 3D meshes Mₖ, corresponding to the geometry of the 3D models representing the GOPs, are obtained by elevation of the estimated 2D meshes as illustrated by the block referenced 80.

The correspondences 78 set up between the vertices of two successive models express the transformation 79, used to pass from a model Mₖ to a model Mₖ₊₁, by means of wavelet coefficients.

The utility of expressing this transformation by wavelengths lies in the fact that the precision of the transformation can be adapted to the bit rate through the natural scalability of the wavelets.

The wavelets used for the decomposition are second-generation wavelets, i.e. they are definable on sets that have no vector space structure. In this case, with the notations of FIG. 6, the wavelets are defined on the basic models MB₀, MB₁, etc.

With the availability of the basic mesh MBᵢ and of the geometrical correspondence between MBᵢ and the 3D model Mᵢ, the wavelet coefficients are generated by an application of analysis filters on a semi-regular re-meshing of Mᵢ. The wavelet coefficients d are the solution of the following linear system:
Td=c
where T is the matrix of total synthesis and where c is the set of the positions of the vertices on the semi-regular re-meshing of Mᵢ.

T depends on the type of wavelets used. Three schemes are given preference in the invention: piecewise affine wavelets, polynomial wavelets (especially Loop wavelets) and wavelets based on the Butterfly subdivision scheme (J. Warren and al., “Multiresolution Analysis for Surfaces of Arbitrary Topological Type,” ACM Transactions on Graphics, vol. 16, pp. 34-73, 1997).

Thus, the matrix T has the form:
T=(PQ)
where P is a sub-matrix that represents solely the subdivision scheme (Affine, Loop, Butterfly, . . . ) and where the sub-matrix Q is the geometrical interpretation of the wavelet coefficients.

In a preferred embodiment of the invention, Q is chosen such that the wavelet coefficients have a zero moment. In general, P and Q may be arbitrary inasmuch as T remains reversible.

FIG. 7 summarizes the approach that has been explained for the GOP k. The following notations are used in this figure:
Iₙ . . . Iₘ are the input pictures;
C_{n,n+p} is the motion field between the pictures Iₙ and Iₙ₊ₚ;
Cₖ is the motion field associated with the GOP k;
C(V) is the set of the correspondents of the points of the set V found by the motion field;
εₘ is the set of support points of the estimation of 3D information (vertices of the mesh used for motion estimation having the highest scores with the Harris and Stephen detector and regularly decimated);
Eₖ is the set of the vertices of the 3D model associated with the GOP k;
Zₖ is the depth map associated with the GOP k;
Kₖ is the picture of the original sequence corresponding to the key picture associated with the GOP k;
Mₖ is the 3D model associated with the GOP k;
Pₘ is the camera position associated with the picture Iₘ;
θₖ is the set of wavelet coefficients defining the transformation of passage between Mₖ and M₊₁;
Vₖ is the set of vertices of the mesh corresponding to the model Mₖ.

The encoder 81 receives inputs on the positions Pₖ of the camera for the different pictures Iₖ of the original sequence, the estimation Mₖ of the textured 3D model, and the wavelet coefficients enabling the transformation of the model Mₖ₋₁ into the model Mₖ.

Simultaneously with the estimation of the 3D models Mₖ of each of the GOPs k, illustrated in FIG. 7, basic models MBᵢ valid for several successive GOPs are constructed.

For this purpose, through the computed motion field Cₖ, the set of particular points detected in the first picture of the GOP k are followed along several pictures of the sequence. More precisely, the presence of the correspondents of these points along several successive GOPs is detected until the number of correspondents included in the analyzed picture is below a predetermined threshold. This threshold must be chosen to ensure the possibility of reconstruction (i.e. estimation of the fundamental matrix); it is chosen for example to be equal to 7. When the number of particular points detected in a GOP is below the threshold, it is deduced therefrom that this GOP should not be associated with the same basic model MBᵢ as the preceding GOPs.

From this subset of particular points, tracked from GOP to GOP, we reconstruct a basic model MBᵢ whose vertices are all present in the models Mₖ associated with the GOPs k along which these points were tracked.

These basic models, or coarse models MBᵢ are then individually decomposed into wavelets. This is achieved by implementing the method described by P. Gioia in “Reducing the number of wavelet coefficients by geometric partitioning,” Computational geometry, Theory and applications, vol. 14, 1999, in relying on the same basic mesh. Each 3D model Mₖ is considered to be a refinement of the coarse basic model MBᵢ.

Thus, the coefficients tᵢ^{k} of FIG. 6 are obtained as follows: the basic meshes coming from a same GOP are identical and, after subdivision, they generate the same semi-regular mesh. Consequently, the coefficients rᵢ^{k} are indexed by the same geometrical vertices when k varies in a same GOP. For each intermediate k, it is therefore possible to define a function f^{k} that makes the difference between the coefficients rᵢ^{k} and rᵢ^{k+1} correspond to each of these vertices. This function fₖ is then decomposed, as earlier, into wavelet coefficients which are the coefficients tᵢ^{k}.

The invention therefore enables the transmission of the geometry of the models associated with the original sequence at low cost since, on the one hand, the basic meshes and, on the other hand, the wavelet coefficients associated with the different models are transmitted.

The applications that can be envisaged in the context of the invention are numerous. The invention can also be applied especially to the encoding of pictures representing a same fixed scene (which may be a set of independent pictures or a video sequence). The compression rates achieved by this type of representation are situated in the low and very low bit rates (typically in the range of 20 kbits/s) and it is therefore possible to envisage portable applications.

Furthermore, the virtual sequence obtained by reprojection (in decoding) possesses all the functions permitted by 3D, such as changing of illumination, stabilization of sequences, free navigation, adding objects etc.

1. Method for representing a sequence of pictures grouped in sets of at least two successive pictures, called GOPs, a textured, meshed three-dimensional model being associated with each of said GOPs, the method comprising:
representing the three-dimensional model associated with the GOP of level n by means of an irregular mesh taking account of at least one vertex of at least the irregular mesh representing the three-dimensional model associated with the GOP of level n−1, said vertex being called common vertex.

2. Method for representing according to claim 1, wherein at least two consecutive three-dimensional models also have, associated with them, a basic model, built from said vertices common to said at least two three-dimensional models.

3. Method for representing according to claim 2, wherein the passage from one of said three-dimensional models to another is done by wavelet transformation, using a first set of wavelet coefficients.

4. Method for representing according to claim 3, wherein one of said three-dimensional models is obtained from said associated basic model by wavelet transformation, using a second set of wavelet coefficients.

5. Method for representing according to claim 1, wherein said irregular mesh of level n is a two-dimensional irregular mesh of one of the pictures of said GOP of level n.

6. Method for representing according to claim 5, wherein said meshed picture is the first picture of said GOP of level n.

7. Method for representing according to claim 1, wherein each of said three-dimensional models is obtained by elevation of said irregular mesh representing it.

8. Method for representing according to claim 5, wherein said irregular two-dimensional mesh is obtained by successive simplifications of a regular triangular mesh of said picture.

9. Method for representing according to claim 5, wherein said irregular two-dimensional mesh is obtained from a Delaunay mesh of predetermined points of interest of said picture.

10. Method for representing according to claim 1, wherein two successive GOPs have at least one common picture.

11. Method for representing according to claim 1, wherein said vertices common to said levels n−1 and n are detected by estimation of motion between the first picture of said GOP of level n−1 and the first picture of said GOP of level n.

12. Method for representing according to claim 11, wherein it includes storing said detected common vertices.

13. Method for representing according to claim 1, wherein said irregular mesh representing said model associated with the GOP of level n also takes account of at least one vertex of at least the irregular mesh representing the model associated with the GOP of level n+1.

14. Method for representing according to claim 4, wherein said second set of wavelet coefficients is generated by the application of at least one analysis filter on a semi-regular re-meshing of said associated three-dimensional model.

15. Method for representing according to any of the claim 3, wherein said wavelets are second-generation wavelets.

16. Method for representing according to any of the claim 3, wherein said wavelets belong to the group comprising:
piecewise affine wavelets;
polynomial wavelets; and
wavelets based on the Butterfly subdivision scheme.

17. A signal representing a sequence of pictures grouped in sets of at least two successive pictures called GOPs, a textured, meshed three-dimensional model being associated with each of said GOPs, wherein the signal comprises:
at least one field comprising a basic model built from vertices common to at least two irregular meshes, each representing a three-dimensional model, said at least two three-dimensional models being associated with at least two successive GOPs;
at least one field comprising a set of wavelet coefficients used for the construction, by wavelet transformation from said basic model, of at least one three-dimensional model associated with one of said GOPs
at least one field comprising at least one texture associated with one of said three-dimensional models; and
at least one field comprising at least one camera position parameter.

18. A device for representing a sequence of pictures implementing the representation method of claim 1.

19. A device for representing a sequence of pictures grouped in sets of at least two successive pictures, called GOPs, a textured, meshed three-dimensional model being associated with each of said GOPs, wherein the device comprises:
means for the building of said three-dimensional models by wavelet transformation of at least one basic model, prepared from vertices common to at least two irregular meshes representing two successive three-dimensional models; and
means for representing said pictures of the sequence from said three-dimensional models, from at least one picture of texture and from at least one camera position parameter.

20. A device for the encoding of a sequence of pictures grouped in sets of at least two successive pictures, called GOPs, a textured, meshed three-dimensional model being associated with each of said GOPs, wherein the device comprises:
means for the encoding of a three-dimensional model associated with the GOP of level n, said three-dimensional model being represented by means of an irregular mesh taking account of at least one vertex of at least one irregular mesh representing the three-dimensional model associated with the GOP of level n−1.

21. Method for the encoding of a sequence of pictures grouped in sets of at least two successive pictures, called GOPs, a textured, meshed three-dimensional model being associated with each of said GOPs, wherein the method comprises encoding a three-dimensional model associated with the GOP of level n, said three-dimensional model being represented by means of an irregular mesh taking account of at least one vertex of at least one irregular mesh representing the three-dimensional model associated with the GOP of level n−1.
